(19) United States
(12) Patent Application Publication
(10) Pub. No.: US 2014/0194341 A1
(43) Pub. Date: Jul. 10, 2014

(54) Silica Compositions

(71) Applicants: Ramanathan S. Lalgudi, Westerville, OH (US); Phillip Denen, London, OH (US); Barry L. McGraw, Westerville, OH (US)

(72) Inventors: Ramanathan S. Lalgudi, Westerville, OH (US); Phillip Denen, London, OH (US); Barry L. McGraw, Westerville, OH (US)

(73) Assignee: BATTELLE MEMORIAL INSTITUTE, Columbus, OH (US)

(21) Appl. No.: 14/118,840

(22) PCT Filed: May 18, 2012
(86) PCT No.: PCT/US2012/038732

§ 371 Date: Mar. 18, 2014

Related U.S. Application Data
(60) Provisional application No. 61/488,034, filed on May 19, 2011.

(51) Int. Cl. A01N 55/00

(52) U.S. Cl. CPC A01N 55/00
USPC 514/1.1; 530/378

(57) ABSTRACT

Compositions are provided, the compositions comprising: a silica compound containing at least one nitrogen atom; and a carboxylated polymer containing at least one nitrogen atom. The compositions may be useful to control algal growth, including harmful algal blooms (HAB).

### CROSS-REFERENCE TO RELATED APPLICATIONS

This application claims priority from U.S. Provisional Patent Application No. 61/488,034, filed May 19, 2011, which is incorporated by reference herein in its entirety.

### BACKGROUND

Eutrophication of aquatic systems is a global environmental concern. Eutrophication refers to the enrichment of available food in aquatic systems. Algae are the cornerstone of the aquatic food web. However, not all algae are functionally or ecologically equivalent.

For instance, harmful algal blooms (HAB) such as those made up of blue-green algae as found in fresh water, contain cyanotoxins and are largely inedible to zooplankton, macro-invertabrates, and fish. Because blue-green algae are not consumed, they often remain on the water's surface for a period upon death, causing unsightly scum and noxious odors. Eventually, the blooms settle to the water's bottom, where microbial decomposition depletes dissolved oxygen. Anoxic bottom waters lead to taste and odor problems, and are detrimental to fish and other aquatic animals. In addition to the deleterious ecological consequences caused by blue-green algae, the intra-cellular toxins themselves can prove poisonous to humans and non-aquatic animals upon ingestion.

In contrast to the inedible blue-greens, non-blue-green algae (e.g., siliceous phytoplankton or diatoms) can and do get consumed by aquatic organisms, thus improving water clarity and increasing biodiversity. Indeed, edible algae help sustain a vigorous fish community.

From a nutrient perspective, blue-green algae require dissolved inorganic phosphorus (e.g., phosphates) and dissolved inorganic nitrogen (e.g., nitrate and ammonia) to grow. The major nutritional requirement of diatoms, on the other hand, is silicon. Thus, it has become evident that the availability and ratios of silica, nitrogen, and phosphorus play a significant role in the control of harmful algal blooms and the promotion of beneficial diatoms. One current approach to manipulate the availability and ratios of nutrients, and thus, the ratio of HAB to beneficial diatoms, in aquatic systems includes the application of flocculants (e.g., aluminum sulphate) to deplete the HAB of phosphorus. However, the use of aluminum sulphate may prove environmentally unfriendly, and may require several applications. Another approach includes adding sand or other silicon-containing substances to the water. However, this latter approach may be hindered by insufficient solubility and accessibility of the silicon.

The present embodiments disclose compositions comprising: silica compounds containing at least one nitrogen atom; and carboxylated polymers containing at least one nitrogen atom. The compositions may be useful to control algal growth. The compositions may provide high levels of silica in the aquatic system to which the compositions are applied due to enhanced solubility of the silica. Moreover, the compositions may be biodegradable.

### SUMMARY

In one embodiment, a composition is provided, the composition comprising: a silica compound containing at least one nitrogen atom; and a carboxylated polymer containing at least one nitrogen atom.

In another embodiment, a composition for controlling algal growth in an aquatic system is provided, the composition comprising: an ionic complex, comprising: (a) a silica compound having the formula:

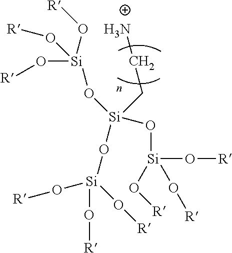

wherein R′=H and n=1−6; and (b) a polymer derived from one or more of: a synthetic or naturally occurring polypeptide, a synthetic carboxylated polymer, a bio-polymer, soy protein, soy bean meal, carboxyl-functional starch, amino-functional starch, cellulose derivatives, and bio-mass obtained from plants.

In another embodiment, a composition is provided, the composition comprising: a sol-gel condensate, comprising: (a) a soy protein or a derivative thereof; and (b) a silica compound having the formula:

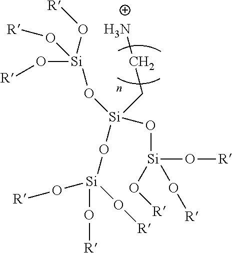

wherein R′=H and n=1−6.

In still another embodiment, a method for controlling algal growth in an aquatic system is provided, the method comprising: treating the aquatic system with a composition, the composition comprising: a silica compound containing at least one nitrogen atom; and a carboxylated polymer containing at least one nitrogen atom.

### BRIEF DESCRIPTION OF THE DRAWINGS

The accompanying figures, which are incorporated in and constitute a part of the specification, illustrate various example systems, methods, results, and so on, and are used merely to illustrate various example embodiments.

FIG. 1 illustrates an example reaction sequence resulting in a composition comprising: a silica compound containing at least one nitrogen atom; and a carboxylated polymer containing at least one nitrogen atom.

FIG. 2 is a flowchart illustrating an example method for controlling algal growth.

### DETAILED DESCRIPTION

The present embodiments disclose compositions and methods that may be useful to control algal growth. In one embodiment, a composition is provided, the composition comprising: a silica compound containing at least one nitrogen atom; and a carboxylated polymer containing at least one nitrogen atom. The silica compound and the polymer may be linked via ionic interactions, or via covalent bonding.

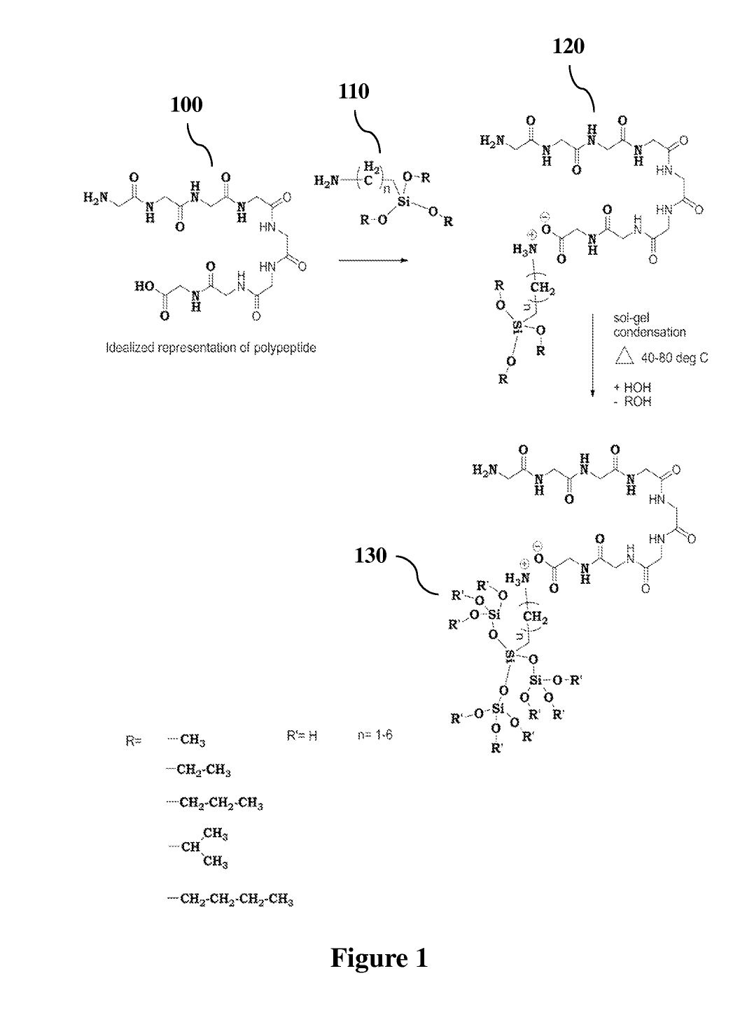

FIG. 1 illustrates an example reaction sequence resulting in a composition comprising: a silica compound containing at least one nitrogen atom; and a carboxylated polymer containing at least one nitrogen atom. As shown in FIG. 1, the polymer containing at least one carboxyl group and at least one nitrogen atom is depicted, for simplicity, as an idealized representation of a polypeptide (100):

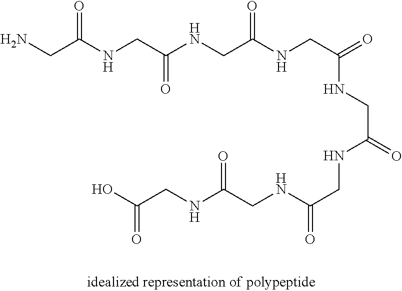 [SMILES: NCC(=O)NCC(=O)NCC(=O)NCC(=O)NCC(=O)NCC(=O)NCC(=O)NCC(=O)O]

In practice, polymer 100 may comprise any polymer containing at least one carboxyl group and at least one nitrogen atom. For example, suitable polymers may include one or more of a synthetic or naturally occurring polypeptide, or a bio-polymer such as soy protein, soy bean meal, carboxyl- or amino-functional starch, cellulose derivatives, such as cationically modified carboxyl methyl cellulose, and bio-mass obtained from plants.

Suitable polymers may also include a synthetic carboxylated polymer, such as, for example, poly(acrylic acid-co-acrylamide), poly(acrylic acid-co-N-isopropyl acrylamide), poly(acrylic acid-co-malimide), poly(acrylic acid-co-N-methyl malimide), poly(acrylic acid-co-N-phenyl malimide), poly(acrylic acid-co-N-vinyl pyrrolidone), poly(acrylic acid-co-N-vinyl imidazole), and poly(acrylic acid-co-N-vinyl carbazole). Such synthetic carboxylated polymers may be made from free radical copolymerization of acrylic acid with monomers such as acrylamide, N-isopropyl acrylamide, malimide, N-methyl malimide, N-phenyl malimide, N-vinyl pyrrolidone, N-vinyl imidazole, and N-vinyl carbazole.

With further reference to FIG. 1, polymer 100 is contacted with an amino-functional silane 110 to form a polymer-silane complex 120. In FIG. 1, amino-functional silane 110 is depicted according to Formula I:

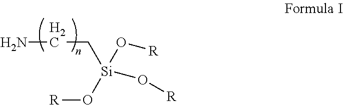

wherein R=methyl, ethyl, n-propyl, i-propyl, or n-butyl; and n−1−6. In particular embodiments, the amino-functional silane may comprise one or more of (CH₃O)₃Si(CH₂)₃NH₂, (CH₃O)₃Si(CH₂)₃N(CH₃)₂, (CH₃)N[(CH₂)₃Si(CH₃O)₃]₂, (CH₃O)₃Si(CH₂)₃N(CH₂CH₃)₂, (CH₃O)₃Si(CH₂)₃NH(CH₃), (CH₃O)₃Si(CH₂)₃N⁺(CH₃)₃.Cl⁻, and(CH₃O)₃Si(CH₂)₃NH[(CH₂)₂NH₂).

Polymer-silane complex 120 is depicted according to Formula II:

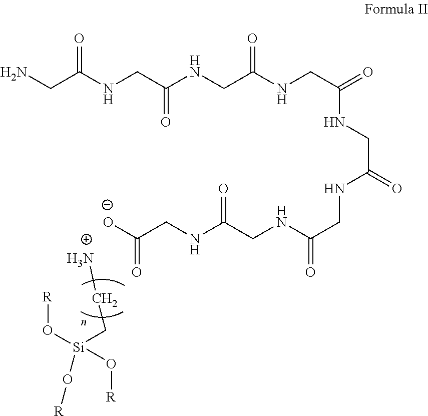

wherein R=methyl, ethyl, n-propyl, i-propyl, or n-butyl; and n=1−6.

As shown in FIG. 1, polymer-silane complex 120 is subjected to sol-gel condensation conditions to form polymer-silica complex 130. Polymer-silica complex 130 is depicted according to Formula III:

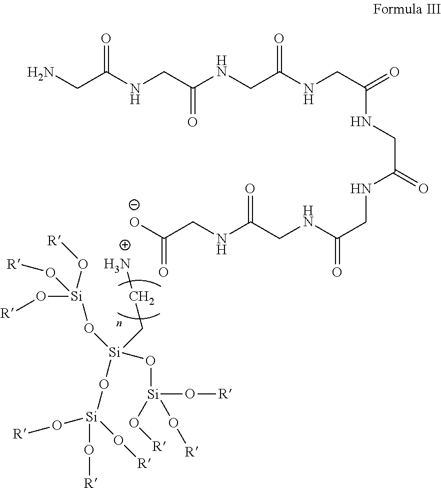

wherein R′=H; and n−1−6.

Complexes 120 and 130 are depicted as being linked via ionic interactions; however, reaction conditions and particular polymer-silica combinations are contemplated wherein the silica compound and the polymer are linked by covalent bonding.

In one embodiment, a method for controlling algal growth in an aquatic system is provided, the method comprising: treating the aquatic system with a composition, the composition comprising: a silica compound containing at least one nitrogen atom; and a carboxylated polymer containing at least one nitrogen atom.

The aquatic system may be marine, fresh, or brackish water. The aquatic system may be natural or artificial. The aquatic system may be a closed water system or open water. The aquatic system may be a culture or field sample, an area of an ocean, bay, estuary, pond, lagoon, lake, river, stream, canal, aquarium, aquaculture system, waste water, cooling tower, water holding or conveying system (e.g., a reservoir or ballast water), fountain, or the like.

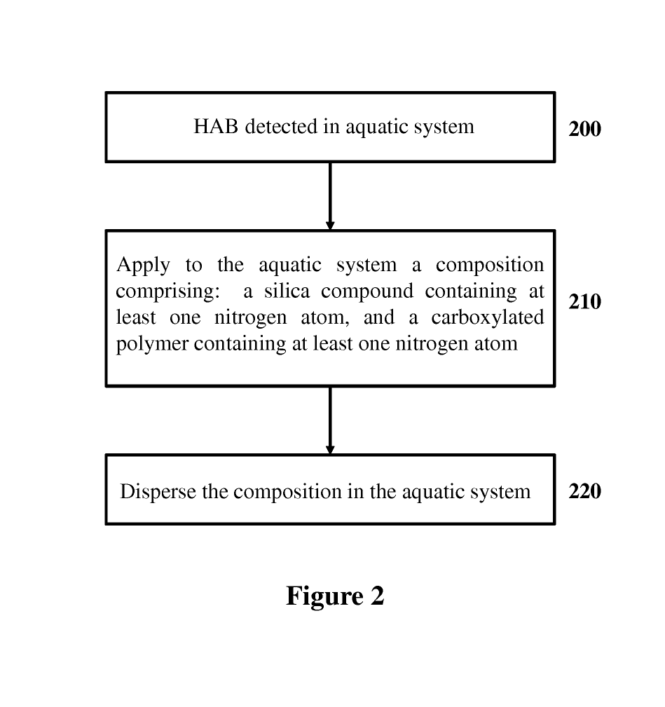

FIG. 2 is a flowchart illustrating an example method for controlling algal growth in an aquatic system. As shown in FIG. 2, HAB is detected in an aquatic system (step 200). A composition comprising a silica compound containing at least one nitrogen atom, and a carboxylated polymer containing at least one nitrogen atom, is applied to the aquatic system (step 210). The composition is dispersed in the aquatic system (step 220).

The detecting may include at least one of: detecting with the senses, e.g., visual detection or perception of odor; detecting at least one of chemically, molecularly, and analytically; and detecting via electronic sensor.

It should be noted that the composition may alternatively be added to the aquatic system before any HAB is detected, e.g., as a preventative measure or prophylaxis. Further still, the composition may be added before any HAB is detected and after a HAB is detected.

Application of the composition may involve broad deployment (e.g., several square miles across and throughout the water column), local deployment (e.g., to a particular effected situs), or both.

Dispersion may include, for example, at least one of gravity dispersion and mechanical dispersion.

### EXAMPLES

### Example 1

### Synthesis of Amino-Functional Silica

Acetone (182 g), distilled water (1 g), and concentrated hydrochloric acid (7.5 g) were charged to a 500 mL plastic beaker containing a magnetic stirrer. The solution was stirred such that a vortex was formed for 1 min, checking the pH. When the pH of the solution dropped below 2, (3-aminopropyl)trimethoxysilane AMPTS (10 g) was quickly added. The reaction mixture was stirred for 16 h. The amino-functional silane product was isolated by centrifuge, followed by drying in a vacuum oven at 40° C.

### Example 2

### Synthesis of Soy Protein/Silica Complex

Procote® PC 4200 (E.I. du Pont de Nemours and Company) (16.2 g) and 300 mL of DI water were charged into a 500 mL glass beaker to form a 5% soy protein solution.

Distilled water (104.5 g) and the amino-functional silane of Example 1 (5.5 g) were charged into a 250 mL three-neck flask. The contents were heated to 60° C. under argon and stirred until the solid amino-functional silane of Example 1 was dissolved. 10% NaOH was charged to the flask to increase the pH to about 8 to form a 5% silica solution.

The 5% soy protein solution (50 mL) was charged into a 250 mL three-neck flask and heated to 40° C. under Argon. The 5% silica solution (50 mL) was slowly charged to the reaction flask under constant stirring and pulsed sonication over a period of 30 min. The contents of the flask were dried at 40° C. for 16 h under reduced pressure to yield isolated soy protein/silica complex.

### Example 3

### Synthesis of Soy Protein/Silica Physical Mixture

Procote® PC 4200 (E.I. du Pont de Nemours and Company) (13.9 g) and 125 mL of DI water were charged into a 250 mL glass beaker to form a soy protein solution.

The soy protein solution was charged into a 250 mL glass jar. Sodium silicate (Cermabond™ 830; Aremco Products, Inc.) (10 g) was added and the mixture was mixed thoroughly by mechanical agitation to form a soy protein/silica complex.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995).

While the present application has been illustrated by the description of particular embodiments, and while the embodiments have been described in considerable detail, it is not an intention to restrict or in any way limit the scope of the appended claims to such detail. With the benefit of the present application, additional advantages and modifications will readily appear to those skilled in the art. Therefore, the application, in its broader aspects, is not limited to the specific details and illustrative examples shown and described. Accordingly, departures may be made from such details without departing from the spirit or scope of the general inventive concept.

1. A composition, comprising:
a silica compound containing at least one nitrogen atom; and
a carboxylated polymer containing at least one nitrogen atom.

2. The composition of claim 1, wherein the silica compound and the carboxylated polymer together form an ionically associated complex.

3. The composition of claim 1, wherein the silica compound and the carboxylated polymer together form an ionically associated complex, and the silica compound has the formula: 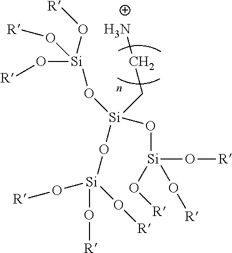
wherein R′=H.

4. The composition of claim 1, wherein the carboxylated polymer is derived from one or more of: a synthetic or naturally occurring polypeptide, a synthetic carboxylated polymer, a bio-polymer, soy protein, soy bean meal, carboxyl-functional starch, ammo-functional starch, cellulose derivatives, and bio-mass obtained from plants.

5. The composition of claim 1, wherein the carboxylated polymer is derived from a soy protein.

6. The composition of claim 1, wherein the silica compound is derived from a silane having the formula: 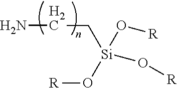
wherein R is selected from methyl, ethyl, n-propyl, 2-propyl, and n-butyl; and
n=1−6.

7. The composition of claim 1, wherein the silica compound is derived from one or more of: (CH₃O)₃Si(CH₂)₃NH₂, (CH₃O)₃Si(CH₂)₃N(CH₃)₂, (CH₃)N[(CH₂)₃Si(CH₃O)₃]₂, (CH₃O)₃Si(CH₂)₃N(CH₂CH₃)₂, (CH₃O)₃Si(CH₂)₃NH(CH₃), (CH₃O)₃Si(CH₂)₃N⁺(CH₃)₃Cl⁻, and (CH₃O)₃Si(CH₂)₃NH[(CH₂)₂NH₂].

8. The composition of claim 1, wherein the silica compound and the carboxylated polymer together form a complex that is covalently bound via an amide linkage.

9. A composition for controlling algal growth in an aquatic system, comprising:
an ionic complex, comprising:
(a) a silica compound, comprising: 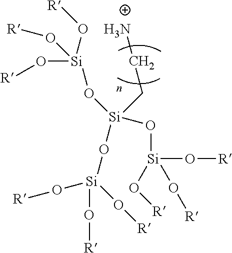
wherein R′=H and n=1−6; and
(b) a polymer derived from one or more of: a synthetic or naturally occurring polypeptide, a synthetic carboxylated polymer, a bio-polymer, soy protein, soy bean meal, carboxyl-functional starch, amino-functional starch, cellulose derivatives, and bio-mass obtained from plants.

10. The composition of claim 9, wherein the polymer comprises a soy protein or a derivative thereof.

11. A composition, comprising:
a sol-gel condensate, comprising:
(a) a soy protein or a derivative thereof; and
(b) a silica compound having the formula: 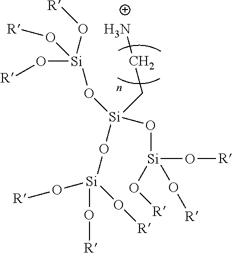
wherein R′=H and n=1−6.

12. A method for controlling algal growth in an aquatic system, the method comprising:
treating the aquatic system with a composition, the composition comprising:
a silica compound containing at least one nitrogen atom; and
a carboxylated polymer containing at least one nitrogen atom.

13. The method of claim 12, wherein the treating follows detection of a harmful algal bloom in the aquatic system.

14. The method of claim 12, wherein:
the silica compound comprises a compound having the formula: 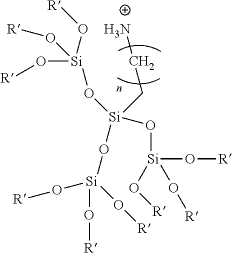
wherein R′=H, and n=1−6; and
the carboxylated polymer comprises at least one of: a synthetic or naturally occurring polypeptide, a synthetic carboxylated polymer, a bio-polymer, soy protein, soy bean meal, carboxyl-functional starch, amino-functional starch, cellulose derivatives, and bio-mass obtained from plants, or a derivative thereof.

15. The method of claim 12, wherein the carboxylated polymer comprises a soy protein or a derivative thereof.
